(19) United States
(12) Patent Application Publication
(10) Pub. No.: US 2024/0404402 A1
(43) Pub. Date: Dec. 5, 2024

(54) TRAFFIC CONTROL METHOD AND APPARATUS, DEVICE, AND STORAGE MEDIUM

(71) Applicant: Tencent Technology (Shenzhen) Company Limited, Shenzhen (CN)

(72) Inventor: Siyang LIU, Shenzhen (CN)

(73) Assignee: Tencent Technology (Shenzhen) Company Limited, Shenzhen (CN)

(21) Appl. No.: 18/802,755

(22) Filed: Aug. 13, 2024

Related U.S. Application Data
(63) Continuation of application No. PCT/CN2023/077605, filed on Feb. 22, 2023.

(30) Foreign Application Priority Data
Jun. 2, 2022 (CN) 202210620442.0

(51) Int. Cl. G08G 1/087; G08G 1/01; H04W 4/44

(52) U.S. Cl. CPC G08G 1/087; G08G 1/0116; G08G 1/0145; H04W 4/44

(57) ABSTRACT

Embodiments of the present disclosure disclose a traffic control method and apparatus, a device, and a storage medium. The method includes: receiving a vehicle intention and request message transmitted by a vehicle, the vehicle intention and request message including signal priority request information, and the signal priority request information including at least one of classification information and load information of the vehicle; and transmitting target signal priority request information in the vehicle intention and request message to a road traffic signal control system, the target signal priority request information including at least one of the classification information and the load information of the vehicle. The target signal priority request information is configured for instructing the road traffic signal control system to determine, based on the target signal priority request information, whether to allow for priority passage of the vehicle at a first intersection.

### RELATED APPLICATION

This application is a continuation of International Patent Application No. PCT/CN2023/077605, filed Feb. 22, 2023, which claims priority to Chinese Patent Application No. 2022106204420, entitled “TRAFFIC CONTROL METHOD AND APPARATUS, DEVICE, AND STORAGE MEDIUM” filed with the China National Intellectual Property Administration on Jun. 2, 2022. The contents of each of International Patent Application No. PCT/CN2023/077605 and Chinese Patent Application No. 2022106204420 are incorporated herein by reference in their entirety.

### FIELD OF THE TECHNOLOGY

The present disclosure relates to the field of Internet of Vehicles technologies, and in particular, to a traffic control technology.

### BACKGROUND OF THE DISCLOSURE

With development of Internet of Vehicles technologies and popularization of vehicles, traffic conditions on a road are increasingly complex. Therefore, traffic control methods are more refined. For example, some vehicles with special purposes need preferential rights-of-way when addressing emergencies.

There is an urgent need for a traffic control method that can implement more accurate control of priority passage of vehicles.

### SUMMARY

Embodiments of the present disclosure provide a traffic control method and apparatus, a device, and a storage medium, which can improve accuracy of controlling priority passage of vehicles.

Embodiments of the present disclosure provide a traffic control method. The method is performed by a road side unit. The method includes: receiving a vehicle intention and request message transmitted by a vehicle, the vehicle intention and request message including signal priority request information, and the signal priority request information including at least one of classification information and load information of the vehicle; and transmitting target signal priority request information in the vehicle intention and request message to a road traffic signal control system, the signal priority request information including the target signal priority request information, and the target signal priority request information including at least one of the classification information and the load information of the vehicle. The target signal priority request information is configured for instructing the road traffic signal control system to determine, based on the target signal priority request information, whether to allow for priority passage of the vehicle.

Embodiments of the present disclosure provide a traffic control method. The method is performed by a road side unit. The method includes: receiving a vehicle intention and request message transmitted by a vehicle, the vehicle intention and request message including signal priority request information, and the signal priority request information including at least one of classification information and load information of the vehicle; and determining, based on the signal priority request information, whether to transmit target signal priority request information in the vehicle intention and request message to a road traffic signal control system, the signal priority request information including the target signal priority request information, and the target signal priority request information including at least one of the classification information and the load information of the vehicle.

Embodiments of the present disclosure provide a traffic control method. The method is performed by a vehicle. The method includes: transmitting a vehicle intention and request message to a road side unit, the vehicle intention and request message including signal priority request information, and the signal priority request information including at least one of classification information and load information of the vehicle. The vehicle intention and request message is configured for instructing the road side unit to transmit target signal priority request information in the vehicle intention and request message to a road traffic signal control system, the signal priority request information includes the target signal priority request information, and the target signal priority request information includes at least one of the classification information and the load information of the vehicle.

Embodiments of the present disclosure provide a traffic control method. The method is performed by a vehicle. The method includes: transmitting a vehicle intention and request message to a road side unit, the vehicle intention and request message including signal priority request information, and the signal priority request information including at least one of classification information and load information of the vehicle. The vehicle intention and request message is configured for instructing the road side unit to determine, based on the signal priority request information, whether to transmit target signal priority request information in the vehicle intention and request message to a road traffic signal control system, the signal priority request information includes the target signal priority request information, and the target signal priority request information includes at least one of the classification information and the load information of the vehicle.

Embodiments of the present disclosure provide a traffic control apparatus. The apparatus is deployed in a road side unit. The apparatus includes: a receiving unit, configured to receive a vehicle intention and request message transmitted by a vehicle, the vehicle intention and request message including signal priority request information, and the signal priority request information including at least one of classification information and load information of the vehicle; and a transmitting unit, configured to transmit target signal priority request information in the vehicle intention and request message to a road traffic signal control system, the signal priority request information including the target signal priority request information, and the target signal priority request information including at least one of the classification information and the load information of the vehicle. The target signal priority request information is configured for instructing the road traffic signal control system to determine, based on the target signal priority request information, whether to allow for priority passage of the vehicle.

Embodiments of the present disclosure provide a traffic control apparatus. The apparatus is deployed in a road side unit. The apparatus includes: a receiving unit, configured to receive a vehicle intention and request message transmitted by a vehicle, the vehicle intention and request message including signal priority request information, and the signal priority request information including at least one of classification information and load information of the vehicle; and a processing unit, configured to determine, based on the signal priority request information, whether to transmit target signal priority request information in the vehicle intention and request message to a road traffic signal control system, the signal priority request information including the target signal priority request information, and the target signal priority request information including at least one of the classification information and the load information of the vehicle.

Embodiments of the present disclosure provide a traffic control apparatus. The apparatus is deployed in a vehicle. The apparatus includes: a transmitting unit, configured to transmit a vehicle intention and request message to a road side unit, the vehicle intention and request message including signal priority request information, and the signal priority request information including at least one of classification information and load information of the vehicle. The vehicle intention and request message is configured for instructing the road side unit to transmit target signal priority request information in the vehicle intention and request message to a road traffic signal control system, and the target signal priority request information includes at least one of the classification information and the load information of the vehicle.

Embodiments of the present disclosure provide a traffic control apparatus. The apparatus is deployed in a vehicle. The apparatus includes: a transmitting unit, configured to transmit a vehicle intention and request message to a road side unit, the vehicle intention and request message including signal priority request information, and the signal priority request information including at least one of classification information and load information of the vehicle. The vehicle intention and request message is configured for instructing the road side unit to determine, based on the signal priority request information, whether to transmit target signal priority request information in the vehicle intention and request message to a road traffic signal control system, the signal priority request information includes the target signal priority request information, and the target signal priority request information includes at least one of the classification information and the load information of the vehicle.

Embodiments of the present disclosure provide a computer device, including a processor, a memory, and an input/output interface. The processor is separately connected to the memory and the input/output interface, the input/output interface is configured to receive data and output data, the memory is configured to store a computer program, and the processor is configured to invoke the computer program, to cause the computer device including the processor to perform the traffic control method in any one of embodiments of the present disclosure.

Embodiments of the present disclosure provide a computer-readable storage medium, having a computer program stored thereon. The computer program is loadable and executable by a processor to cause a computer device having the processor to perform the traffic control method in any one of embodiments of the present disclosure.

Embodiments of the present disclosure provide a computer program product or a computer program. The computer program product or the computer program includes computer instructions. The computer instructions are stored on a computer-readable storage medium. A processor of a computer device reads the computer instructions from the computer-readable storage medium, and the processor executes the computer instructions, to cause the computer device to perform the traffic control method provided in various implementations in any one of embodiments of the present disclosure.

According to technical solutions provided in some embodiments of the present disclosure, the vehicle intention and request message transmitted by the vehicle to the road side unit is enhanced, so that the signal priority request information in the vehicle intention and request message includes at least one of the classification information and the load information of the vehicle. Furthermore, when the road side unit transmits the target signal priority request information in the vehicle intention and request message to the road traffic signal control system, the road traffic signal control system is enabled to more accurately determine, based on at least one of the classification information and the load information of the vehicle included in the target signal priority request information, whether to allow for priority passage of the vehicle, thereby improving the accuracy of controlling priority passage of vehicle.

### BRIEF DESCRIPTION OF THE DRAWINGS

FIG. 1 is a diagram of a system architecture of a traffic control method according to an embodiment of the present disclosure.

FIG. 2 is a diagram of a system architecture of another traffic control method according to an embodiment of the present disclosure.

FIG. 3 is a flowchart of a traffic control method according to an embodiment of the present disclosure.

FIG. 4 is a flowchart of another traffic control method according to an embodiment of the present disclosure.

FIG. 5 is a schematic interaction diagram of a traffic control method according to an embodiment of the present disclosure.

FIG. 6 is a diagram of an architecture of a traffic control system according to an embodiment of the present disclosure.

FIG. 7 is a diagram of an architecture of another traffic control system according to an embodiment of the present disclosure.

FIG. 8 is a schematic diagram of a traffic control apparatus according to an embodiment of the present disclosure.

FIG. 9 is a schematic diagram of another traffic control apparatus according to an embodiment of the present disclosure.

FIG. 10 is a schematic diagram of a structure of a computer device according to an embodiment of the present disclosure.

### DESCRIPTION OF EMBODIMENTS

Phrases and terms involved in embodiments of the present disclosure are explained below.

An intelligent vehicle infrastructure cooperative system (IVIC), which may be referred to as a vehicle infrastructure cooperative system for short, indicates one of development directions of an intelligent traffic system (ITS). The vehicle infrastructure cooperative system uses advanced wireless communication and new-generation Internet technologies to comprehensively implement dynamic vehicle-vehicle and vehicle-infrastructure information interaction in real time. Based on collection and integration of cross-time-and-space dynamic traffic information, active vehicle safety control and road collaborative management are carried out to implement effective collaboration between pedestrians, vehicles, and infrastructures, ensure traffic safety, and improve traffic efficiency, thereby forming a safe, efficient, and environmentally friendly road traffic system.

Intersection: Because roads are distributed to form a network structure, there are a plurality of intersections where the roads intersect each other. The intersections may be of different types, such as crossroads, T-intersections, and Y-intersections. A crossroad is an intersection where two roads intersect each other and form a cross shape, and a T-intersection is an intersection where two roads intersect each other and form a T shape. A junction point between roads is an intersection. In road engineering, the intersection is also referred to as a junction, which refers to a junction point where two or more roads come together.

Lane: The term “lane” refers to a roadway on which a vehicle travels, and is also referred to as a traffic lane. Generally, solid lines or dashed lines are used to divide lanes on roads. Lanes near an intersection generally include lanes corresponding to different driving directions, such as a left-turn lane, a straight-ahead lane, a right-turn lane, a U-turn lane, and a lane of multiple directions, such as a left-turn and straight-ahead lane, a straight-ahead and right-turn lane, or a left-turn and U-turn lane.

Phase of signal lights: Because intersections connect different roads and provide space for vehicles to switch to other roads, intersections are prone to traffic disturbance. To coordinate traffic at intersections, signal lights (or road traffic lights) are usually provided at intersections to control vehicle movement. For example, there are generally four sets of signal lights at a crossroad (each branch corresponds to one set of signal lights), and a combination of states of all the signal lights at the crossroad is referred to as a phase. At a standard crossroad, there are twelve vehicle movement modes, which are going straight ahead (cast to west, west to cast, south to north, and north to south), making a small turn (cast to north, west to south, north to west, and south to cast), making a large turn (cast to south, west to north, north to cast, and south to west), respectively. A vehicle movement mode on a branch can be controlled through signal lights on the branch. The foregoing twelve vehicle movement modes can be combined with each other to form a phase. For example, an east-west straight-ahead phase includes two movement modes: cast to west and west to cast. The vehicle movement modes at the entire intersection can be controlled through signal light phases. Therefore, working states of the signal lights at the intersection can also be represented as signal light phases.

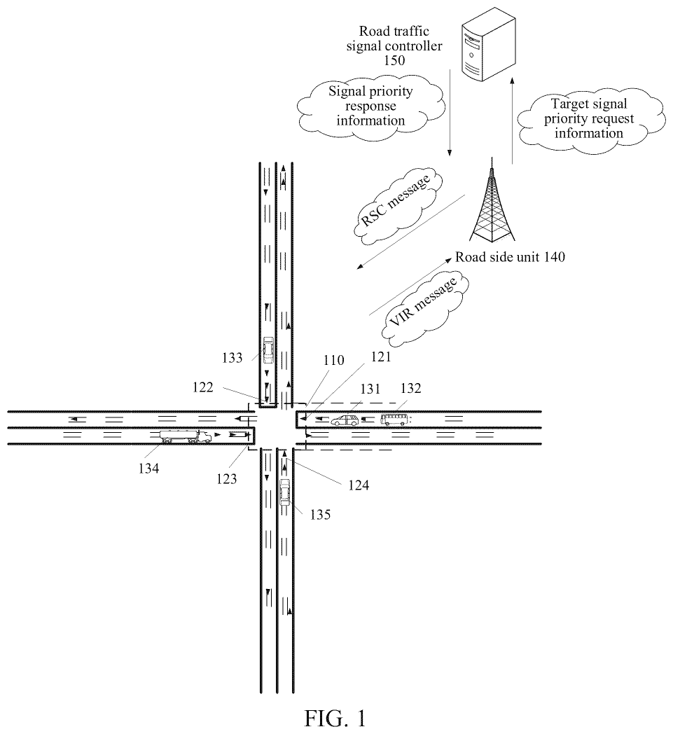

In an embodiment of FIG. 1, an example in which an intersection 110 is a crossroad is used, and the crossroad has four entrances: an entrance 121, an entrance 122, an entrance 123, and an entrance 124. There are a vehicle 131 and a vehicle 132 traveling on a lane where the entrance 121 is located. There is a vehicle 133 traveling on a lane where the entrance 122 is located. There is a vehicle 134 on a lane where the entrance 123 is located. There is a vehicle 135 on a lane where the entrance 124 is located. Types of intersections, a quantity of entrances to each intersection, classifications of vehicles, and a quantity of vehicles entering each entrance are not limited in the present disclosure.

As shown in FIG. 1, a system architecture of a traffic control method may include: a road side unit 140 corresponding to the intersection 110, and a road traffic signal controller 150 corresponding to the road side unit 140.

Any one or more of the vehicle 131, the vehicle 132, the vehicle 133, the vehicle 134, and the vehicle 135 can transmit a vehicle intention and request message (VIR message for short) to the road side unit 140. The VIR message may include signal priority request information. The signal priority request information may include at least one of classification information and load information (for example, when the vehicle is a bus, the load information may be bus occupancy rate information) of a corresponding vehicle.

For example, if the vehicle 131 is a car, the VIR message transmitted by the vehicle 131 to the road side unit 140 may include vehicle classification information. The vehicle classification information may indicate that the vehicle 131 is a car.

For another example, if the vehicle 132 is a bus, the VIR message transmitted by the vehicle 132 to the road side unit 140 may include vehicle classification information and bus occupancy rate information. The vehicle classification information may indicate that the vehicle 132 is a bus.

Still referring to FIG. 1, in some embodiments, after receiving the VIR message from a vehicle, the road side unit 140 may directly transmit at least part of the signal priority request information in the VIR message to the corresponding road traffic signal controller 150 as target signal priority request information. The target signal priority request information may include at least one of classification information and load information of the vehicle.

In some other embodiments, after the road side unit 140 receives the VIR message from the vehicle, the road side unit 140 first determines, based on the target signal priority request information included in the VIR message, whether to forward the target signal priority request information to the corresponding road traffic signal controller 150.

For example, when determining, based on the classification information of the vehicle in the VIR message, that the vehicle transmitting the VIR message is a special vehicle (such as a bus, a fire vehicle, and a police vehicle), the road side unit 140 forwards the target signal priority request information to the corresponding road traffic signal controller 150. If it is determined that the vehicle is a non-special vehicle, the road side unit 140 may not forward the target signal priority request information to the road traffic controller 150.

For another example, when determining, based on the classification information of the vehicle in the VIR message, that the vehicle transmitting the VIR message is a bus and the load information in the VIR message indicates that a bus occupancy rate exceeds a set threshold, the road side unit 140 forwards the target signal priority request information to the corresponding road traffic signal controller 150. The set threshold may be set according to needs of an actual scenario. A value of the set threshold is not limited in the present disclosure. If it is determined that the vehicle is a non-special vehicle, or although it is determined that the vehicle is a bus, which is a special vehicle, an occupancy rate of the bus is less than or equal to the set threshold, the road side unit 140 may not forward the target signal priority request information to the road traffic controller 150.

After the road traffic signal controller 150 receives the target signal priority request information transmitted by the road side unit 140, the road traffic signal controller 150 may determine, based on the target signal priority request information, whether to allow for priority passage of the corresponding vehicle at an entrance corresponding to the intersection 110.

For example, the road traffic signal controller 150 may determine, based on the classification information of the vehicle in the target signal priority request information, that the corresponding vehicle is a special vehicle and then may allow for priority passage of the corresponding vehicle through the entrance of the intersection.

For another example, the road traffic signal controller 150 may determine, based on the classification information and the load information of the vehicle in the target signal priority request information, that the corresponding vehicle is a bus among the special vehicles and the bus occupancy rate exceeds the set threshold, and then may allow for priority passage of the corresponding vehicle through the entrance of the intersection.

In some embodiments, the road side unit 140 may receive a plurality of VIR messages transmitted from a plurality of vehicles at a plurality of different entrances to the same intersection 110, and may alternatively receive a plurality of VIR messages transmitted from a plurality of vehicles at a same entrance to the same intersection 110. The road side unit 140 may process each VIR message separately, that is, determine, based on signal priority request information carried in each VIR message, whether to forward target signal priority request information in a corresponding VIR message to the road traffic signal controller 150.

For example, if receiving a plurality of VIR messages, the road side unit 140 may determine, based on classification information of a vehicle carried in each VIR message, whether to forward corresponding target signal priority request information to the road traffic signal controller 150. If it is determined that the corresponding vehicle is a special vehicle, target signal priority request information in a corresponding VIR message is forwarded to the road traffic signal controller 150. If it is determined that the corresponding vehicle is a non-special vehicle, target signal priority request information in a corresponding VIR message is not forwarded to the road traffic signal controller 150. Alternatively, if it is determined that the corresponding vehicle is a bus, only target signal priority request information carried in a VIR message transmitted by a bus with an occupancy rate higher than 50% is forwarded to the road traffic signal controller 150.

In some other embodiments, the road side unit 140 may receive a plurality of VIR messages transmitted from a plurality of vehicles at a plurality of different entrances to the same intersection 110, and may alternatively receive a plurality of VIR messages transmitted from a plurality of vehicles at the same entrance to the same intersection 110. Based on all received VIR messages, the road side unit 140 determines to forward target signal priority request information in all the VIR messages or part of the VIR messages to the road traffic signal controller 150, or determines not to forward signal priority request information in all the VIR messages to the road traffic signal controller 150.

For example, assuming that the road side unit 140 simultaneously receives VIR messages from the vehicle 131 and the vehicle 132, the road side unit 140 may determine that the vehicle 131 is a car and the vehicle 132 is a bus, and in this case, may determine to forward target signal priority request information carried in the VIR message transmitted by the vehicle 132 to the road traffic signal controller 150, but not to forward target signal priority request information carried in the VIR message transmitted by the vehicle 131 to the road traffic signal controller 150.

In some embodiments, the road traffic signal controller 150 may receive target signal priority request information carried in a plurality of VIR messages transmitted from a plurality of vehicles at a plurality of different entrances to the same intersection 110, and may alternatively receive target signal priority request information carried in a plurality of VIR messages transmitted from a plurality of vehicles at the same entrance to the same intersection 110. The road traffic signal controller 150 may separately process target signal priority request information carried in each VIR message. To be specific, it is determined, based on the target signal priority request information carried in each VIR message, whether to allow for priority passage of a corresponding vehicle.

For example, if receiving target signal priority request information carried in a plurality of VIR messages, the road traffic signal controller 150 may determine, based on classification information of a vehicle carried in each piece of target signal priority request information, whether to allow for priority passage of the corresponding vehicle. If it is determined that the corresponding vehicle is a special vehicle, the corresponding vehicle is allowed for priority passage. If it is determined that the corresponding vehicle is a non-special vehicle, the corresponding vehicle is not allowed for priority passage. Alternatively, if it is determined that the corresponding vehicle is a bus, only a bus with an occupancy rate higher than 50% is allowed for priority passage.

In some other embodiments, the road traffic signal controller 150 may receive target signal priority request information carried in a plurality of VIR messages transmitted from a plurality of vehicles at a plurality of different entrances to the same intersection 110, and may alternatively receive target signal priority request information carried in a plurality of VIR messages transmitted from a plurality of vehicles at the same entrance to the same intersection 110. Based on all received target signal priority request information, the road traffic signal controller 150 may determine which vehicle among the plurality of vehicles are allowed for priority passage.

For example, assuming that the road traffic signal controller 150 simultaneously receives target signal priority request information carried in VIR messages from the vehicle 131 and the vehicle 132, the road traffic signal controller 150 may determine that the vehicle 131 is a car and the vehicle 132 is a bus, and in this case, may allow for priority passage of the vehicle 132 at the intersection 110, but not allow for priority passage of the vehicle 131 at the intersection 110.

According to the method provided in embodiments of the present disclosure, at least one of the classification information and the load information of the vehicle is added to the VIR message, so that a road side communication device can more accurately determine whether to transmit the target signal priority request information in the VIR message to the road traffic signal control system, or the road traffic signal control system can more accurately determine whether to allow for priority passage of the vehicle. Further, based on the VIR messages transmitted by the plurality of vehicles at the same intersection, the road side communication device may determine to forward target signal priority request information in VIR messages of which vehicle. Therefore, a data processing volume of the road traffic signal control system and a data transmission volume between the road side communication device and the road traffic signal control system can be reduced. In addition, making a decision based on the plurality of VIR messages can better balance traffic conditions of the plurality of vehicles at the intersection to achieve higher traffic efficiency. In addition, based on the target signal priority request information carried in the VIR messages transmitted by the plurality of vehicles at the same intersection, the road traffic signal control system may determine which vehicle are allowed to have priority passage, to further balance the traffic conditions between the plurality of vehicles at the intersection to achieve higher traffic efficiency.

In one embodiment, after determination of the road traffic signal controller 150 is made based on the target signal priority request information, signal priority response information may be generated. The signal priority response information may include at least one of signal priority type information and signal priority duration information, and the signal priority response information is returned to the road side unit 140.

After receiving the signal priority response information returned by the road traffic signal controller 150, the road side unit 140 may generate a road side coordination (RSC) message. The RSC message may include at least one of the signal priority type information and the signal priority duration information, and the RSC message is returned to a corresponding vehicle.

When receiving the RSC message, a vehicle transmitting the VIR message in FIG. 1 may make a future decision based on at least one of the signal priority type information and the signal priority duration information included in the RSC message.

In embodiments of the present disclosure, further, the addition of at least one of the signal priority type information and the signal priority duration information to the RSC message enables the vehicle to obtain detailed signal priority response information provided by the road traffic control system, so that the vehicle can make a future decision based on at least one of the obtained signal priority type information and signal priority duration information.

For example, the vehicle and the road side unit 140, as well as the road side unit 140 and the road traffic signal controller 150, may be connected via a network, and the network may be a wireless network or a wired network. In one embodiment, the road side unit 140 may be disposed near an intersection to monitor a vehicle through the intersection. A model of the road side unit is not limited in embodiments of the present disclosure. The road traffic signal controller 150 may be configured to control a traffic control device (such as signal lights, but the traffic control device is not limited thereto in the present disclosure) of at least one entrance to the intersection. A model of the road traffic signal controller 150 is not limited in embodiments of this application.

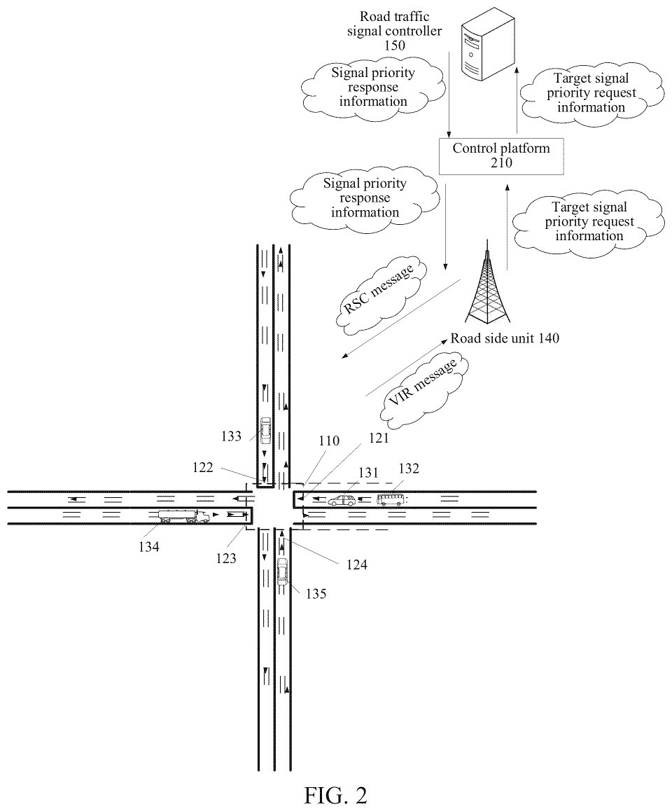

As shown in FIG. 2, a road traffic signal control system may further include: a control platform 210. The control platform 210 may be connected to one or more road side units to one or more road traffic signal controllers. For example, the control platform 210 may be connected to one or more road side units and one or more road traffic signal controllers separately via a network, and the network may be a wireless network or a wired network.

For example, the control platform 210 may be connected to a road side unit 140 (which may be referred to as a first road side unit) of an intersection 110 (to distinguish the intersection 110 from other intersections, which may be referred to as a first intersection hereafter) and a second road side unit (not shown in the figure) of a second intersection, and may be connected to a road traffic signal controller 150 (which may also be referred to as a first road traffic signal controller) of the first intersection and a second road traffic signal controller (not shown in the figure) of the second intersection. According to the traffic control method provided in embodiments of the present disclosure, the road side unit 140 may receive a VIR message transmitted by a vehicle (which may be referred to as a first vehicle) that is to enter the first intersection, and may transmit target signal priority request information carried in the VIR message to the control platform 210. The control platform 210 may transmit the target signal priority request information (which may be referred to as first target signal priority request information for distinction) to the road traffic signal controller 150.

In addition, according to the traffic control method provided in embodiments of the present disclosure, the second road side unit may also receive a VIR message transmitted by a vehicle (which may be referred to as a second vehicle) that is to enter the second intersection, and may transmit target signal priority request information carried in the VIR message to the control platform 210. The control platform 210 may transmit the target signal priority request information (which may be referred to as second target signal priority request information for distinction) to the second road traffic signal controller.

In one embodiment, the control platform 210 may separately receive the target signal priority request information transmitted by the first road side unit and the second road side unit, and separately forward each piece of target signal priority request information to the first road traffic signal controller and the second road traffic signal controller. Based on at least one of classification information and load information of the vehicle carried in the target signal priority request information transmitted by the first road side unit, the first road traffic signal controller may determine whether to allow for priority passage of the first vehicle, and return corresponding signal priority response information (which may be referred to as first signal priority response information) to the control platform 210. The control platform 210 may return the first signal priority response information to the first road side unit. The first road side unit generates a corresponding RSC message (which may be referred to as a first RSC message) based on the first signal priority response information, and transmits the first RSC message to the first vehicle.

Based on at least one of classification information and load information of the vehicle carried in the target signal priority request information transmitted by the second road side unit, the second road traffic signal controller may determine whether to allow for priority passage of the second vehicle, and return corresponding signal priority response information (which may be referred to as second signal priority response information) to the control platform 210. The control platform 210 may return the second signal priority response information to the second road side unit. The second road side unit generates a corresponding RSC message (which may be referred to as a second RSC message) based on the second signal priority response information, and transmits the second RSC message to the second vehicle. The first intersection and the second intersection may be intersections having an associated relationship, such as intersections adjacent to each other, and intersections belonging to the same geographical area.

In embodiments of the present disclosure, based on the target signal priority request information carried in the VIR messages transmitted by the plurality of vehicles at the plurality of intersections, the control platform may also determine which vehicle are allowed to have priority passage in order to further balance traffic conditions between the plurality of intersections and/or to facilitate implementing an overall traffic balance to improve overall traffic efficiency.

The control platform 210 may be a cellular-vehicle to everything (C-V2X) cloud control platform.

For example, the control platform 210 is an electronic device that may be connected to one or more road side units and one or more road traffic signal controllers, such as a server or a terminal. In one embodiment, when the control platform 210 is a server, the server may be an independent physical server, or may be a server cluster or distributed system composed of a plurality of physical servers, or may be a cloud server providing basic cloud computing services, such as cloud services, cloud databases, cloud computing, cloud functions, cloud storage, network services, cloud communications, middleware services, domain name services, security services, content delivery network (CDN), and big data and artificial intelligence platforms. In one embodiment, when the control platform 210 is a terminal device, the terminal may be a mobile phone, a vehicle-mounted terminal, a computer, or a smart voice interaction device, but is not limited thereto.

A person skilled in the art may understand that quantities of intersections 110, entrances 121 to 124, vehicles 131 to 135, road side units 140, road traffic signal controllers 150 in FIG. 1, and quantities of road side units 140, second road side units, road traffic signal controllers 150, second road traffic signal controllers, and control platforms 210 in the embodiment of FIG. 2 are merely examples. According to actual implementation needs, there can be any quantity of road side units, road traffic signal controllers, and control platforms 210. This is not limited in embodiments of the present disclosure.

The following further describes the exemplary implementations in detail with reference to the accompanying drawings and embodiments.

First, embodiments of the present disclosure provide a traffic control method. The method is applicable to interaction between a vehicle, a road side unit, and a corresponding road traffic signal control system at an intersection. Alternatively, the method is applicable to interaction between a vehicle, a road side unit, a road traffic signal control system, and a control platform at an intersection.

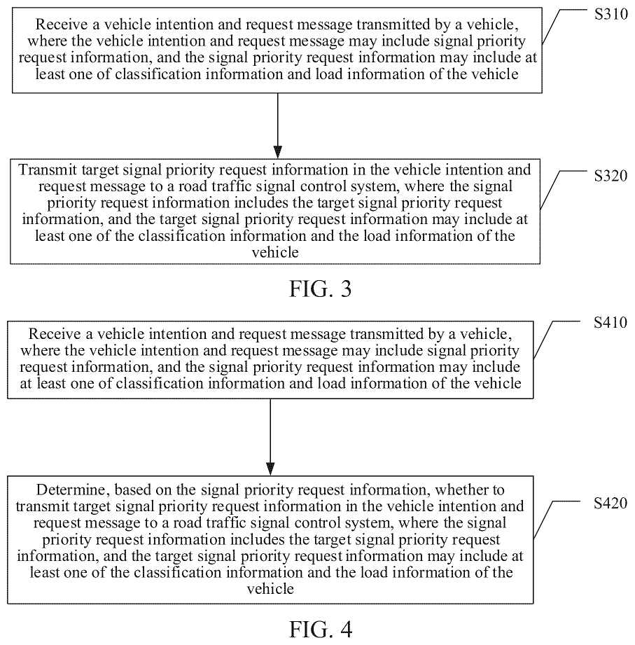

FIG. 3 is a flowchart of a traffic control method according to an embodiment of the present disclosure. An example in which the method is applied to interaction between a vehicle, a road side unit, and a road traffic signal control system at an intersection is used in the embodiment of the present disclosure. The foregoing vehicle, road side unit, road traffic signal control system, and control platform may be included in an intelligent vehicle infrastructure cooperative system.

As shown in FIG. 3, the method provided in the embodiment of FIG. 3 may be performed by the road side unit at an intersection. The traffic control method provided in the embodiment of the present disclosure may include the following operations.

S310: Receive a vehicle intention and request message (VIR message) transmitted by a vehicle, where the vehicle intention and request message may include signal priority request information, and the signal priority request information may include at least one of classification information and load information of the vehicle.

A positional relationship between the road side unit and the intersection is not limited in embodiments of the present disclosure, provided that the road side unit can detect a vehicle that is about to enter the intersection.

In an exemplary embodiment, the intersection may be a crossroad, a T-intersection, a Y-intersection, or the like. For example, the intersection is a crossroad. As shown in FIG. 1 and FIG. 2, it is assumed that the intersection may include four entrances, namely an entrance 121, an entrance 122, an entrance 123, and an entrance 124.

A quantity of and types of vehicles transmitting VIR messages are also not limited in embodiments of the present disclosure. For example, the quantity of vehicles transmitting VIR messages may be determined based on an application scenario. The vehicle in embodiments of the present disclosure may refer to any one or more of vehicles, pedestrians (for example, by using corresponding electronic devices), infrastructures, and the like that participate in traffic and can transmit VIR messages.

In embodiments of the present disclosure, the signal priority request information refers to any information that is transmitted by the vehicle and related to requesting priority passage from the road side unit or the road traffic signal control system. In other words, the road side unit or the road traffic signal control system may determine, based on the signal priority request information, whether to allow for priority passage of the vehicle at the entrance of the intersection. The signal priority request information may include, for example, but is not limited to: one or more of a position where the vehicle is currently located, information about an intersection that the vehicle is to enter currently (such as an entrance map of the intersection), information (such as a status of signal lights corresponding to the entrance) about an entrance that the vehicle is to enter currently, a lane where the vehicle is currently located, type information of the lane (for example, the lane is a straight-ahead lane or a right-turn lane), a manner of priority passage requested by the vehicle (for example, U-turn priority passage, left-turn priority passage, or straight-ahead priority passage).

In embodiments of the present disclosure, the signal priority request information in the VIR message may include classification information of the vehicle. The classification information of the vehicle may include a basic class of the vehicle. For example, the basic class here may be divided according to a function of the vehicle. For example, the vehicle may be any one of a bus, a police vehicle, a fire vehicle, or an emergency ambulance. The classification information of the vehicle may further include a type of a component of the vehicle, such as any one or more of a fuel power type and an engine model of a vehicle.

In an exemplary embodiment, when the signal priority request information includes the classification information of the vehicle, the vehicle intention and request message may include a data frame (DF for short) of a vehicle classification (which may be represented as VehicleClassification, but is not limited thereto in the present disclosure). The data frame of the vehicle classification may be configured for carrying the classification information of the vehicle.

In an exemplary embodiment, the classification information of the vehicle may include basic class information of the vehicle. The data frame of the vehicle classification may include a data element (DE for short) of a basic vehicle class (which may be represented as Basic VehicleClass, but is not limited thereto in the present disclosure). The data element of the basic vehicle class may be configured for carrying the basic class information of the vehicle.

In an exemplary embodiment, the classification information of the vehicle may further include fuel power type information of the vehicle. The data frame of the vehicle classification may further include a data element of a fuel power type (which may be represented as FuelType, but is not limited thereto in the present disclosure). The data element of the fuel power type may be configured for carrying the fuel power type information of the vehicle.

In embodiments of the present disclosure, the signal priority request information in the VIR message may include load information of the vehicle. The load information of the vehicle refers to information related to at least one of the people and objects loaded on the vehicle. Corresponding load information of the vehicle may be determined based on the classification information of the vehicle.

For example, if the vehicle is a passenger motor vehicle, the load information of the vehicle may be at least one of information such as an occupancy rate and a passenger capacity of the vehicle. The passenger capacity refers to a quantity of people carried on the vehicle, and the occupancy rate refers to a ratio between the passenger capacity of the vehicle and a rated passenger capacity. The rated passenger capacity refers to the specified maximum quantity of people that the vehicle can carry.

For another example, if the vehicle is a vehicle transporting goods, the load information of the vehicle may be any one or more of a weight, a volume, a shape, a type, and the like of the goods loaded on the vehicle.

In an exemplary embodiment, the vehicle intention and request message may include a data frame of intention and request data (which may be represented as IntentionAndRequest Data, IARData for short, but is not limited thereto in the present disclosure).

The data frame of the intention and request data may include a data frame of a driving request (which may be represented as DriveRequest, but is not limited thereto in the present disclosure).

The data frame of the driving request may include a data frame of request information (which may be represented as ReqInfo, but is not limited thereto in the present disclosure).

The data frame of the request information may include a data frame of a signal priority request (which may be represented as Req-SignalPriority, but is not limited thereto in the present disclosure).

When the signal priority request information includes the load information of the vehicle, and the vehicle is a bus, the data frame of the signal priority request may include a data element of a bus occupancy rate (which may be represented as busPassengerCap, but is not limited thereto in the present disclosure).

The data element of the bus occupancy rate may be configured for carrying the load information of the vehicle.

In some embodiments, the signal priority request information in the VIR message may include the classification information and the load information of the vehicle.

S320: Transmit target signal priority request information in the vehicle intention and request message to a road traffic signal control system, where the signal priority request information includes the target signal priority request information, and the target signal priority request information may include at least one of the classification information and the load information of the vehicle.

The target signal priority request information may be configured for instructing the road traffic signal control system to determine, based on the target signal priority request information, whether to allow for priority passage of the vehicle.

In embodiments of the present disclosure, after receiving the VIR message transmitted by the vehicle, the road side unit may forward at least part of the signal priority request information in the VIR message to the corresponding road traffic signal control system as the target signal priority request information, so that the road traffic signal control system determines, based on the received target signal priority request information, whether to allow for priority passage of the vehicle at the entrance of the intersection.

According to the traffic control method provided in embodiments of the present disclosure, at least one of the classification information and the load information of the vehicle is added to the VIR message, and the target signal priority request information also carries at least one of the classification information and the load information of the vehicle, so that the road traffic signal control system can more accurately determine whether to allow for priority passage of the vehicle.

Further, in the traffic control method provided in embodiments of the present disclosure, the road traffic signal control system does not need to perform determination based on both a basic safety message (BSM, for lane change warning, blind spot warning, intersection collision warning, and the like) and the VIR message. According to embodiments of the present disclosure, the classification information of the vehicle may be obtained only based on the VIR message, so that it may be determined, based on the classification information of the vehicle, whether to allow priority (that is, priority passage) of the vehicle, thereby reducing a processing delay and complexity. In addition, the BSM message is more commonly used in a vehicle to vehicle (V2V, a communication between vehicle units) scenario, and the road traffic signal control system does not necessarily process or even does not process the BSM message. In addition, in actual scenarios, because a quantity of ordinary vehicles (non-special vehicles) is far more than that of special vehicles, a quantity of BSM messages is far more than that of VIR messages. If priority of BSM message processing is identical to priority of VIR message processing, processing complexity for the road traffic signal control system is to be greatly increased.

In an exemplary embodiment, the method provided in embodiments of the present disclosure may further include: receiving signal priority response information transmitted by the road traffic signal control system, where the signal priority response information may include at least one of signal priority type information and signal priority duration information; generating a road side coordination message based on the signal priority response information, where the road side coordination message may include at least one of the signal priority type information and signal priority duration information; and transmitting the road side coordination message to the vehicle.

In embodiments of the present disclosure, after making a decision, based on the received target signal priority request information, on whether to allow for priority passage of the vehicle at a specific entrance of a corresponding intersection, the road traffic control system may generate signal priority response information and return the signal priority response information to the corresponding road side unit. The signal priority response information refers to any relevant information that is in response to the target signal priority request information transmitted by the vehicle and that is configured for indicating whether to allow for priority passage of the vehicle, and in one embodiment, may further include a priority passage policy when it is determined that the vehicle is allowed for priority passage. The priority passage policy may include at least one of the signal priority type information and the signal priority duration information.

In embodiments of the present disclosure, the signal priority type information refers to information related to a priority type of signal lights corresponding to the target signal priority request information, for example, whether the signal lights perform red light truncation or green light extension.

In embodiments of the present disclosure, the signal priority duration information refers to information related to priority duration of an action performed by signal lights corresponding to the target signal priority request information, for example, extending green light duration of the signal lights by 10 seconds.

In an exemplary embodiment, the road side coordination message may include a data frame of vehicle coordination (which may be represented as VehicleCoordination, but is not limited thereto in the present disclosure).

The data frame of the vehicle coordination may include a data frame of signal priority information response (which may be represented as Resp-SPInfo, but is not limited thereto in the present disclosure).

The data frame of the signal priority information response may include at least one of a data element of a signal priority type (which may be represented as Resp-PriorityType, but is not limited thereto in the present disclosure) and a data element of signal priority duration (which may be represented as TimeOffset, but is not limited thereto in the present disclosure).

The data element of the signal priority type may be configured for indicating the signal priority type information.

The data element of the signal priority duration may be configured for indicating the signal priority duration information.

According to the traffic control method provided in embodiments of the present disclosure, further, the addition of at least one of the signal priority type information and the signal priority duration information to the RSC message enables the vehicle to obtain detailed signal priority response information provided by the road traffic control system, so that the vehicle may make an accurate assessment of a signal priority effect of the previously transmitted VIR message based on at least one of the obtained signal priority type information and signal priority duration information, so that the vehicle makes a subsequent decision, for example, to no longer initiate a signal priority request using a VIR message, or to initiate a signal priority request using a VIR message again. If a signal priority request is initiated using a VIR message again, requested priority duration may be further determined based on at least one of the obtained signal priority type information and signal priority duration information.

FIG. 4 is a flowchart of a traffic control method according to an embodiment of the present disclosure. An example in which the method is applied to interaction between a vehicle, a road side unit, and a road traffic signal control system at any intersection is used in the embodiment of the present disclosure. The foregoing vehicle, road side unit, road traffic signal control system, and control platform may be included in an intelligent vehicle infrastructure cooperative system.

As shown in FIG. 4, the method provided in the embodiment of FIG. 4 may be performed by the road side unit at any intersection. The traffic control method provided in the embodiment of the present disclosure may include the following operations.

S410: Receive a vehicle intention and request message transmitted by a vehicle, where the vehicle intention and request message may include signal priority request information, and the signal priority request information may include at least one of classification information and load information of the vehicle.

For specific implementations of S410, reference may be made to S310 in the embodiment of FIG. 3.

S420: Determine, based on the signal priority request information, whether to transmit target signal priority request information in the vehicle intention and request message to a road traffic signal control system, where the signal priority request information includes the target signal priority request information, and the target signal priority request information may include at least one of the classification information and the load information of the vehicle.

In the embodiment of FIG. 4, after receiving the VIR message transmitted by the vehicle, the road side unit may first determine, based on the signal priority request information carried in the VIR message, such as at least one of the classification information and the load information of the vehicle, whether to forward the target signal priority request information carried in the VIR message to the corresponding road traffic signal control system.

For example, if it is determined, based on the classification information of the vehicle, that the vehicle is a special vehicle, then the target signal priority request information in the VIR message is forwarded to the corresponding road traffic signal control system. If it is determined, based on the classification information of the vehicle, that the vehicle is a non-special vehicle, then the target signal priority request information in the VIR message is not forwarded to the corresponding road traffic signal control system.

For another example, if it is determined, based on the classification information of the vehicle, that the vehicle is a bus and it is determined, based on the load information of the vehicle, that a bus occupancy rate exceeds 50%, then the target signal priority request information in the VIR message is forwarded to the corresponding road traffic signal control system. If it is determined, based on the classification information of the vehicle, that the vehicle is a bus but it is determined, based on the load information of the vehicle, that a bus occupancy rate is less than 50%, then the target signal priority request information in the VIR message is not forwarded to the corresponding road traffic signal control system.

According to the traffic control method provided in embodiments of the present disclosure, at least one of the classification information and the load information of the vehicle is added to the VIR message, so that a road side unit can more accurately determine whether to transmit the target signal priority request information in the VIR message to the road traffic signal control system, to reduce an amount of communication data between the road side unit and the road traffic signal control system, and reduce a data processing volume of the road traffic signal control system, to improve processing efficiency. In addition, the target signal priority request information carries at least one of the classification information and the load information of the vehicle, so that the road traffic signal control system can more accurately determine whether to allow for priority passage of the vehicle.

Further, according to the traffic control method provided in embodiments of the present disclosure, the road side unit does not need to perform determination based on both a basic safety message and the VIR message. According to embodiments of the present disclosure, the classification information of the vehicle may be obtained only based on the VIR message, so that it may be determined, based on the classification information of the vehicle, whether to forward the target signal priority request information, thereby reducing a processing delay and complexity. In addition, the BSM message is more commonly used in V2V scenarios. The road side unit does not necessarily process or even does not process the BSM message. In addition, in actual scenarios, because a quantity of ordinary vehicles (non-special vehicles) is far more than that of special vehicles, a quantity of BSM messages is far more than that of VIR messages. If priority of BSM message processing is identical to priority of VIR message processing, processing complexity for the road side unit is greatly increased.

In an exemplary embodiment, the method provided in embodiments of the present disclosure may further include: forwarding the target signal priority request information to the road traffic signal control system when it is determined, based on the signal priority request information, to transmit the target signal priority request information in the vehicle intention and request message to the road traffic signal control system; receiving signal priority response information from the road traffic signal control system, where the signal priority response information may include at least one of signal priority type information and signal priority duration information; generating a road side coordination message based on the signal priority response information, where the road side coordination message may include at least one of the signal priority type information and signal priority duration information; and transmitting the road side coordination message to the vehicle.

For other content of the embodiment of FIG. 4, reference may be made to the descriptions of the embodiment of FIG. 3.

According to the traffic control method provided in embodiments of the present disclosure, further, the addition of at least one of the signal priority type information and the signal priority duration information to the RSC message enables the vehicle to obtain detailed signal priority response information provided by the road traffic control system, so that the vehicle may make an accurate assessment of a signal priority effect of the previously transmitted VIR message based on at least one of the obtained signal priority type information and signal priority duration information, so that the vehicle makes a subsequent decision, for example, to no longer initiate a signal priority request using a VIR message, or to initiate a signal priority request using a VIR message again. If a signal priority request is initiated using a VIR message again, requested priority duration may be further determined based on at least one of the obtained signal priority type information and signal priority duration information.

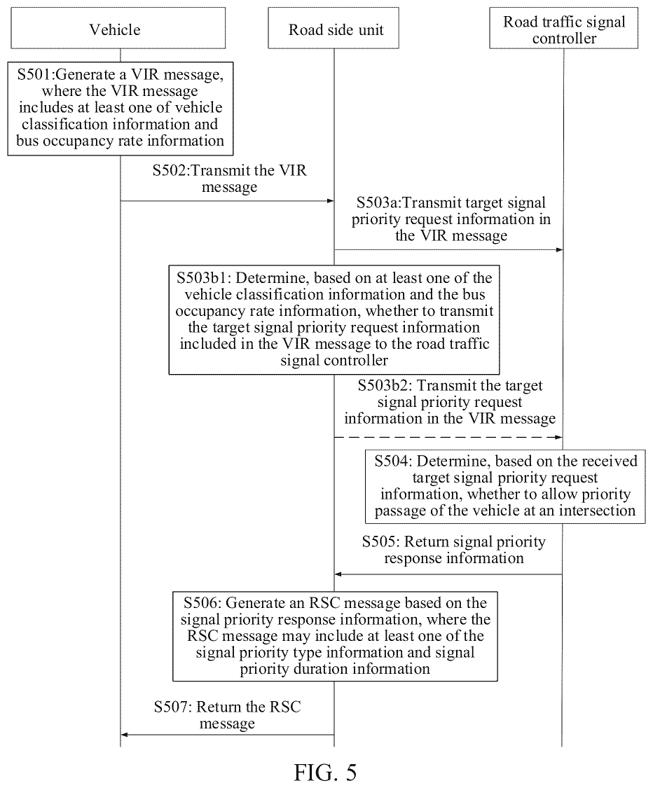

An embodiment of FIG. 5 is described by using an example in which load information of a vehicle includes bus occupancy rate information. As shown in FIG. 5, the traffic control method provided in embodiments of the present disclosure may include:

S501: When a vehicle is traveling to an intersection and is to enter the intersection from an entrance of the intersection, if the vehicle has a priority passage need, the vehicle may generate a VIR message, where the VIR message includes at least one of vehicle classification information and bus occupancy rate information.

S502: The vehicle transmits the generated VIR message to a road side unit corresponding to the intersection. The road side unit receives the VIR message.

In one embodiment, S503a: The road side unit directly transmits target signal priority request information in the received VIR message to a corresponding road traffic signal controller.

In one embodiment, S503b1: The road side unit first determines, based on the target signal priority request information, such as at least one of the vehicle classification information and the bus occupancy rate information, in the received VIR message, whether to transmit the target signal priority request information included in the VIR message to the road traffic signal controller.

S503b2: When the road side unit determines, based on at least one of the vehicle classification information and the bus occupancy rate information, to transmit the target signal priority request information to the road traffic signal controller, the road side unit forwards the target signal priority request information to the corresponding road traffic signal controller.

S504: After the road traffic signal controller receives the target signal priority request information, the road traffic signal controller may determine, based on the received target signal priority request information, whether to allow for priority passage of the vehicle at the entrance of the intersection, and generate corresponding signal priority response information, where the signal priority response information may include at least one of signal priority type information and signal priority duration information.

S505: The road traffic signal controller returns the signal priority response information to the road side unit.

S506: The road side unit receives the signal priority response information, and generates an RSC message based on the signal priority response information, where the RSC message may include at least one of the signal priority type information and signal priority duration information.

S507: The road side unit transmits the RSC message to the vehicle.

For other content of the embodiment of FIG. 5, reference may be made to the descriptions of other embodiments.

According to the traffic control method provided in embodiments of the present disclosure, at least one of classification information and load information of the vehicle is added to the VIR message, so that a road side communication device can more accurately determine whether to transmit the target signal priority request information to the road traffic signal control system; and the target signal priority request information carries at least one of the classification information and the load information of the vehicle, so that the road traffic signal control system can more accurately determine whether to allow for priority passage of the vehicle. The road side unit may obtain the classification information of the vehicle only based on the VIR message, thereby reducing a processing delay and complexity. In addition, the addition of at least one of the signal priority type information and the signal priority duration information to the RSC message enables the vehicle to obtain the detailed signal priority response information provided by the road traffic control system, so that the vehicle can accurately evaluate a signal priority effect of the previously transmitted VIR message based on at least one of the obtained signal priority type information and signal priority duration information, to facilitate subsequent decision-making of the vehicle.

The traffic control method provided in embodiments of the present disclosure may be applied to interaction between the road side communication device, such as the road side unit (RSU), and the vehicle for a signal priority request and response.

In some embodiments, a “vehicle classification”, a “bus occupancy rate”, and other information may be added to a data frame of a signal priority request. The information helps the road side unit determine more accurately whether to initiate the signal priority request to the road traffic signal control system.

In other embodiments, a data frame of “response information to a vehicle signal priority request (that is, the signal priority information response)” may be added to the RSC message, so that the vehicle can obtain more signal priority information provided by the road traffic signal control system, so that the vehicle evaluates a signal priority effect and makes a subsequent decision (for example, to no longer initiate a signal priority request or to initiate a signal priority request again, where if the signal priority request is initiated again, request priority duration may be determined).

The following uses a C-V2X signal priority request as an example. A method of the C-V2X signal priority request is as follows:

(1) A vehicle having a C-V2X on board unit (OBU) initiates a signal priority request to a C-V2X RSU, by using, for example, a vehicle intention and request message (VIR message). The VIR message may include different types of intentions and requests, one of which is a signal priority request, as shown in Table 1 below, and reference may also be made to corresponding abstract syntax notation one (ASN.1) code below:

TABLE 1
Signal priority request (Msg_VIR)

| Data | Remark |
|---|---|
| ID of a request object | Identity (ID) of a requested target RSU |
| | (such as targetRSU in ASN.) |
| Moment | Moment of transmitting a VIR message |
| | (such as secMark in ASN.1) |
| Position | Position of a requesting object (such |
| | as a vehicle transmitting the VIR |
| | message) (which may be an actual |
| | longitude-latitude position, such as |
| | refPos in ASN.1; or may indicate a |
| | position in a map, such as currentPos |
| | in ASN.1) |
| Request type | Signal priority (such as Req-SignalPriority |
| | in ReqInfo in ASN.1) |
| Request status | Unknown, request, confirmed, canceled, |
| | or completed (such as ReqStatus in ASN.1) |
| Request priority | From low (000) to high (111) |
| | (such as reqPriority in ASN.1) |
| Intersection identity | Such as intersectionId in ASN.1 |
| ID requested for | |
| signal priority | |
| Signal light phase | Such as requiredMov in ASN.1 |
| requested for signal | |
| priority | |
| Estimated time of | Such as estimatedArrivalTime in ASN.1 |
| arrival at the | |
| intersection | |
| Estimated distance | Such as distance2Intersection in ASN.1 |
| to the intersection | |
| requested priority | Such as lifetime in ASN.1 |
| duration | |
| Vehicle classification | Such as vehicleClass in ASN.1 |
| requesting signal | |
| priority | |
| Occupancy rate of a | Such as busPassengerCap in ASM.1 |
| bus requesting for | |
| signal priority | |

In actual scenarios, only a special vehicle can initiate a signal priority request (such as a bus, a fire vehicle, an ambulance vehicle, and a police vehicle) in general. According to embodiments of the present disclosure, the vehicle classification information is included in the signal priority request VIR message, so that the V-V2X RSU can more accurately determine whether to grant signal priority to the vehicle. If the signal priority request is initiated by a non-special vehicle, the V-V2X RSU may refuse to grant signal priority, and does not even need to forward the target signal priority request information to the road signal control system.

In addition, for a bus, there is no need to grant signal priority when there is a small quantity of passengers thereon. Therefore, according to embodiments of the present disclosure, the bus occupancy rate information is included in the signal priority request VIR message, so that it can be more accurately determined whether to grant signal priority to the vehicle. For example, if the signal priority request is initiated by a bus with an occupancy rate of less than 50%, it is not necessary to grant signal priority, and it is not even necessary to forward the target signal priority request information to the road signal control system.

Although the C-V2X OBU may transmit a BSM message, the BSM message is more commonly used in a V2V scenario. The road side unit does not necessarily process or even does not process the BSM message. Even if the BSM message is processed, the C-V2X RSU needs to determine, based on both the BSM message and the VIR message, whether to grant signal priority, which increases a processing delay and complexity. More importantly, in actual scenarios, a quantity of BSM messages is far more than that of VIR messages (a quantity of non-special vehicles is far more than that of special vehicles). If priority of BSM message processing is identical to priority of VIR message processing, processing complexity for the RSU is to be greatly increased.

According to embodiments of the present disclosure, the VIR message is enhanced, so that more information is added to the VIR message. For example, a “vehicle classification”, a “bus occupancy rate”, and other information are added to a VIR data frame. This helps the road side unit determine more accurately whether to initiate the signal priority request to the road traffic signal control system.

The following describes an example of VIR message (Msg_VIR) enhancement to add the vehicle classification information. The vehicle classification may include but is not limited to: a bus an ambulance vehicle, a fire vehicle, a police vehicle, and the like.

ASN.1 code of the VIR message enhancement (adding the vehicle classification information) is as follows:

### Definition

Vehicle intention and request message, configured to transmit information such as a vehicle driving intention, a priority request, and a collaboration request.

[ASN.1 code]

VehIntention AndRequest ::= SEQUENCE {
msgCntMsgCount,

Message count, where msgCnt indicates that a sender numbers the similar messages sent by the sender in sequence. When initiating a specific type of data, the sender may randomly select a starting number and then increment numbers sequentially. The sender may alternatively choose to use the same MsgCount message serial number when sending the same data frame continuously.

```
      id OCTET STRING (SIZE(8)),
      -- temporary vehicle ID
      -- same as id in BSM, i.e., same as vehicle temporary ID in BSM
message
      secMarkDSecond,
      refPos Position3D,
      -- vehicle real position relates to secMark -- i.e., an actual
position of the vehicle at a moment when the VIR message is transmitted
      intAndReqIARData,
      -- vehicle intention and request
  vehicleClass VehicleClassification -- i.e., a data frame of a vehicle
classification
      ...
    }
```

### DF_VehicleClassification

### Definition

It defines a classification of vehicles. Vehicle classification may be defined from a plurality of dimensions.

It may include a basic vehicle class, as well as a fuel power type.

[ASN.1 code]

```
VehicleClassification ::= SEQUENCE {
  classification BasicVehicleClass,
  fuelTypeFuelType OPTIONAL,
  ...
}
```

### DE_Basic VehicleClass

### Definition

It defines a basic vehicle class.

[ASN.1 code]

```
  Basic VehicleClass ::= INTEGER (0 .. 255)
  -- The value of Basic VehicleClass is an integer between 0 and 255
  unknown VehicleClassBasic VehicleClass ::= 0
  -- Not Equipped, Not known or unavailable -- i.e., if the value of the
Basic VehicleClass data element is 0, it indicates that a basic class of the vehicle is unknown
or cannot be obtained
  special VehicleClassBasic VehicleClass ::= 1
  -- Special use -- i.e., if the value of the Basic VehicleClass data element is 1,
it indicates that the vehicle is a special vehicle
  -- Basic Passenger Motor Vehicle Types
  --
```

passenger-Vehicle-TypeUnknownBasic VehicleClass::=10—default type—i.e., if the value of the Basic VehicleClass data element is 10, it indicates that a basic passenger motor vehicle type is unknown
passenger-Vehicle-TypeOtherBasic VehicleClass::=11
various fuel types are handled in another element—i.e., if the value of the Basic VehicleClass data element is 11, it indicates that a basic passenger motor vehicle types is another type, and different types of fuel power types may be processed in another data element.

--
-- Light Trucks, Pickup, Van, Panel
--

lightTruck-Vehicle-TypeUnknownBasic VehicleClass::=20—default type—i.e., if the value of the Basic VehicleClass data element is 20, it indicates that a basic type of the light truck is unknown
lightTruck-Vehicle-TypeOtherBasic VehicleClass::=21—i.e., if the value of the Basic VehicleClass data element is 21, it indicates that the basic type of the light truck is other types

--
-- Trucks, Various axle types -- i.e., trucks with various axle types
--

truck-Vehicle-TypeUnknownBasic VehicleClass::=25—default type—i.e., if the value of the Basic VehicleClass data element is 25, it indicates that a basic class of the truck is unknown
truck-Vehicle-TypeOtherBasic VehicleClass::=26—i.e., if the value of the Basic VehicleClass data element is 26, it indicates that a basic class of the truck is another class
truck-axleCnt2 Basic VehicleClass::=27—Two axle, six tire single units—i.e., if the value of the Basic VehicleClass data element is 27, it indicates that the truck has two axles and six tire single units
truck-axleCnt3 Basic VehicleClass::=28—Two axle, six tire single, units—i.e., if the value of the Basic VehicleClass data element is 28, it indicates that the truck has two axles and a plurality of single units
truck-axleCnt4 Basic VehicleClass::=29—Four or more axle, single unit—i.e., the value of the Basic VehicleClass data element is 29, it indicates that the truck has four or more axles and a single unit
truck-axleCnt4Trailer Basic VehicleClass::=30—Four or less axle, single trailer—i.e., if the value of the Basic VehicleClass data element is 30, it indicates that the truck has four or more axles and a single trailer
truck-axleCnt5Trailer Basic VehicleClass::=31—Five or less axle, single trailer—i.e., if the value of the Basic VehicleClass data element is 31, it indicates that the truck has five or less axles and a single trailer
truck-axleCnt6Trailer Basic VehicleClass::=32—Six or more axle, single trailer—i.e., if the value of the Basic VehicleClass data element is 32, it indicates that the truck has six or more axles and a single trailer
truck-axleCnt5MultiTrailer Basic VehicleClass::=33—Five or less axle, multi-trailer—i.e., if the value of the Basic VehicleClass data element is 33, it indicates that the truck has five or less axles and a plurality of trailers
truck-axleCnt6MultiTrailer Basic VehicleClass::=34—Six axle, multi-trailer—i.e., if the value of the Basic VehicleClass data element is 34, it indicates that the truck has six axles and a plurality of trailers
truck-axleCnt7MultiTrailer Basic VehicleClass::=35—Seven or more axle, multi-trailer—i.e., if the value of the Basic VehicleClass data element is 35, it indicates that the truck has seven or more axles and a plurality of trailers

--
-- Motorcycle Types
--

motorcycle-TypeUnknownBasic VehicleClass::=40—default type—i.e., if the value of the Basic VehicleClass data element is 40, it indicates that a basic motorcycle class is unknown
motorcycle-TypeOtherBasic VehicleClass::=41—i.e., if the value of the Basic VehicleClass data element is 41, it indicates that the motorcycle is of another class
motorcycle-Cruiser-Standard Basic VehicleClass::=42—i.e., if the value of the Basic VehicleClass data element is 42, it indicates that the motorcycle is a cruiser standard motorcycle
motorcycle-SportTouringBasic VehicleClass::=44—i.e., if the value of the Basic VehicleClass data element is 44, it indicates that the motorcycle is a sports touring motorcycle
motorcycle-SuperSportBasic VehicleClass::=45—i.e., if the value of the Basic VehicleClass data element is 45, it indicates that the motorcycle is a super sports motorcycle
motorcycle-Touring Basic VehicleClass::=46—i.e., if the value of the Basic VehicleClass data element is 46, it indicates that the motorcycle is a touring motorcycle
motorcycle-Trike Basic VehicleClass::=47—i.e., if the value of the Basic VehicleClass data element is 47, it indicates that the motorcycle is a three-wheeled motorcycle

--
-- Transit Types
--

transit-TypeUnknownBasic VehicleClass::=50—default type, the default type—i.e., if the value of the Basic VehicleClass data element is 50, it indicates that a transit type of the vehicle is unknown
transit-TypeOtherBasic VehicleClass::=51—i.e., if the value of the Basic VehicleClass data element is 51, it indicates that the vehicle is of another transit type
transit-BRT Basic VehicleClass::=52—i.e., if the value of the Basic VehicleClass data element is 52, it indicates that the vehicle belongs to a bus rapid transit system and BRT is the abbreviation of Bus Rapid Transit
transit-ExpressBusBasic VehicleClass::=53—i.e., if the value of the Basic VehicleClass data element is 53, it indicates that the vehicle is a rapid transit bus
transit-LocalBusBasic VehicleClass::=54—i.e., if the value of the Basic VehicleClass data element is 54, it indicates that the vehicle is a local bus
transit-SchoolBusBasic VehicleClass::=55—i.e., if the value of the Basic VehicleClass data element is 55, it indicates that the vehicle is a school bus
transit-FixedGuidewayBasic VehicleClass::=56—i.e., if the value of the Basic VehicleClass data element is 56, it indicates that the vehicle is transported on a fixed guide way
transit-ParatransitBasic VehicleClass::=57—i.e., if the value of the Basic VehicleClass data element is 57, it indicates that the vehicle belongs to a sub-public transportation system
transit-Paratransit-Ambulance Basic VehicleClass::=58—i.e., if the value of the Basic VehicleClass data element is 58, it indicates that the vehicle is an auxiliary transport ambulance

--
-- Emergency Vehicle Types
--

emergency-TypeUnknownBasic VehicleClass::=60—default type—i.e., if the value of the Basic VehicleClass data element is 60, it indicates that the vehicle is an emergency vehicle, but it is unknown what kind of emergency vehicle the vehicle is
emergency-TypeOtherBasic VehicleClass::=61—includes federal users—i.e., if the value of the Basic VehicleClass data element is 61, it indicates that the vehicle is an emergency vehicle but belongs to another type
emergency-Fire-Light-Vehicle Basic VehicleClass::=62—i.e., if the value of the Basic VehicleClass data element is 62, it indicates that the vehicle is a light fire vehicle
emergency-Fire-Heavy-Vehicle Basic VehicleClass::=63—i.e., if the value of the Basic VehicleClass data element is 63, it indicates that the vehicle is a heavy fire vehicle
emergency-Fire-Paramedic-Vehicle Basic VehicleClass::=64—i.e., if the value of the Basic VehicleClass data element is 64, it indicates that the vehicle is a paramedic fire vehicle
emergency-Fire-Ambulance-Vehicle Basic VehicleClass::=65—i.e., if the value of the Basic VehicleClass data element is 65, it indicates that the vehicle is a fire ambulance vehicle
emergency-Police-Light-Vehicle Basic VehicleClass::=66—i.e., if the value of the Basic VehicleClass data element is 66, it indicates that the vehicle is a light police vehicle
emergency-Police-Heavy-Vehicle Basic VehicleClass::=67—i.e., if the value of the Basic VehicleClass data element is 67, it indicates that the vehicle is a heavy police vehicle
emergency-Other-Responder Basic VehicleClass::=68—i.e., if the value of the Basic VehicleClass data element is 68, it indicates that the vehicle is an emergency vehicle with another responder
emergency-Other-Ambulance Basic VehicleClass::=69—i.e., if the value of the Basic VehicleClass data element is 69, it indicates that the vehicle is another ambulance vehicle

--
-- Other V2X Equipped Travelers
--

otherTraveler-TypeUnknownBasic VehicleClass::=80—default type—i.e., if the value of the Basic VehicleClass data element is 80, it indicates that the VIR message is transmitted by other travelers of unknown type
otherTraveler-TypeOtherBasic VehicleClass::=81—i.e., if the value of the Basic VehicleClass data element is 81, it indicates that the VIR message is transmitted by other types of travelers
otherTraveler-Pedestrian Basic VehicleClass::=82—i.e., if the value of the Basic VehicleClass data element is 82, it indicates that the VIR message is transmitted by a passing pedestrian
otherTraveler-Visually-Disabled Basic VehicleClass::=83—i.e., if the value of the Basic VehicleClass data element is 83, it indicates that the VIR message is transmitted by a visually disabled traveler
otherTraveler-Physically-Disabled Basic VehicleClass::=84—i.e., if the value of the Basic VehicleClass data element is 84, it indicates that the VIR message is transmitted by a physically disabled traveler
otherTraveler-Bicycle Basic VehicleClass::=85—i.e., if the value of the Basic VehicleClass data element is 85, it indicates that the VIR message is transmitted by a bicycle traveler
otherTraveler-Vulnerable-RoadworkerBasic VehicleClass::=86—i.e., if the value of the Basic VehicleClass data element is 86, it indicates that the VIR message is transmitted by a vulnerable road worker

--
-- Other V2X Equipped Device Types
--

infrastructure-TypeUnknownBasic VehicleClass::=90—default type—i.e., if the value of the Basic VehicleClass data element is 90, it indicates that the VIR message is transmitted by an infrastructure, but a infrastructure type is unknown
infrastructure-Fixed Basic VehicleClass::=91—i.e., if the value of the Basic VehicleClass data element is 91, it indicates that the VIR message is transmitted by a fixed infrastructure
infrastructure-Movable Basic VehicleClass::=92—i.e., if the value of the Basic VehicleClass data element is 92, it indicates that the VIR message is transmitted by movable infrastructure
equipped-CargoTrailerBasic VehicleClass::=93—i.e., if the value of the Basic VehicleClass data element is 93, it indicates that the VIR message is transmitted by a trailer equipped with cargo.

The foregoing ASN.1 code of Basic VehicleClass is merely used as an example for description. In other embodiments, different values may be used to indicate different basic vehicle classes. For example, a Basic VehicleClass value of 1 indicates a bus, a Basic VehicleClass value of 2 indicates a fire vehicle, and a Basic VehicleClass value of 3 indicates a police vehicle.

### DF_IARData

### Definition

It defines a travel plan and request information of a vehicle.

It includes a vehicle's current position in a map, planned driving route, related driving behavior, request message, and the like.

[ASN.1 code]

```
  IARData ::= SEQUENCE {
    currentPosPathPlanningPoint OPTIONAL,
    -- current position in MAP -- i.e., vehicle's current position in a map,
which is optional
    path-Planning PathPlanning OPTIONAL,
    -- real time path planning that is shared with neighbors -- i.e., a real
time planned path shared by the vehicle with neighboring vehicles, which
is optional
    -- list in chronological order
    currentBehaviorDriveBehavior OPTIONAL,
    -- drive behavior related to the path planning -- i.e., a driving
behavior related to the planned path, which is optional
    reqs SEQUENCE (SIZE(1..8)) OF DriveRequest OPTIONAL --
i.e., a driving request, which is optional
    ...
  }
```

### DF_DriveRequest

### Defintion

It defines request information issued by a vehicle.

It includes an identifier (ID) of this request message and an operation status of the request message, and optional fields include priority of a request, a temporary identifier of a target vehicle, a temporary identifier of a target RSU, content of the request, a validity period of the message, and the like.

[ASN.1 code]

```
  DriveRequest ::= SEQUENCE {
    reqID INTEGER (0 .. 255),
    -- local ID of this request
    -- same request in serial VIR messages should keep the same reqID
    status ReqStatus,
    reqPriority OCTET STRING (SIZE(1)) OPTIONAL,
  -- The lower five bits are reserved and shall be set to zero, and
reqPriority is optional
    -- Value from B00000000 to B11100000 represents the lowest to the
highest level
    targetVeh OCTET STRING (SIZE(8)) OPTIONAL,
    -- the temporary ID of target vehicle, which is optional
    targetRSU OCTET STRING (SIZE(8)) OPTIONAL,
    -- the temporary ID of target RSU, which is optional
    info ReqInfo OPTIONAL, -- request information, i.e., content of a
request, which is optional
    life Time TimeOffset OPTIONAL,
    -- Lifetime of this request, which is optional
    -- Time offset is calculated from secMark of this message
    ...
  }
```

### DF_ReqInfo

It defines a request message of a vehicle.

It includes a lane change request (Req-LaneChange), a way clearing request (Req-ClearTheWay), a signal priority request (Req-SignalPriority), a sensor information sharing request (Req-SensorSharing), a parking area request (Req-ParkingArea), and the like.

[ASN.1 code]

```
ReqInfo ::= CHOICE {
  laneChangeReq-LaneChange,
  clearThe WayReq-ClearThe Way,
  signalPriorityReq-SignalPriority,
  sensorSharingReq-SensorSharing,
  parking Req-ParkingArea,
  ...
}
```

According to embodiments of the present disclosure, a Req-SignalPriority data frame in IARDa-DriveRequest-ReqInfo in the VIR message (Msg_VIR) is enhanced by adding a “bus occupancy rate” data element, which is as described below.

### DF_Req-SignalPriority

### Definition

It defines signal light priority request information.

It includes an intersection identity (ID) and a signal light phase requested for signal light priority, estimated time of arrival, and a distance from the intersection.

[ASN.1 code]

```
    Req-SignalPriority ::= SEQUENCE {
      intersectionIdNodeReferenceID,
      -- Intersection id indicating the target traffic signal -- i.e., an
intersection identity (ID) requested for signal light priority
      requiredMovMovementEx,
      -- Movement info. required including remote intersection id, target
phase id and turning direction -- i.e., a signal light phase and a turning
direction requested for signal light priority
      estimatedArrivalTimeTimeOffset OPTIONAL,
      -- Estimated arrival time to the intersection, which is optional
      distance2Intersection INTEGER (0..10000) OPTIONAL,
      -- Unit 0.1m -- i.e., a distance between the vehicle and the
intersection, which is measured by a unit of 0.1 m, and is optional
  busPassengerCap INTEGER (0..100) OPTIONAL,
      -- passenger capacity in bus, which is optional and is an integer
between 0 to 100
      ...
    }
```

### DF_MovementEx

### Definition

It describes extension information about a connection relationship between a road and a downstream road section.

Extension content includes adding optional fields to indicate a corresponding turning behavior.

[ASN.1 code]

```
  MovementEx ::= SEQUENCE {
    remoteIntersectionNodeReferenceID,
    -- This entry indicates the downstream intersection of the link this
lane connects to.
    -- This provides a means to create meshes of lanes
    phaseIdPhaseID OPTIONAL,
    -- The matching signal group send by
    -- the SPAT message for this lane/maneuver -- a matched signal
group transmitted by a signal phase and time (SPAT) for this lane/
maneuver
    -- Shall be present unless the connectingLane
    -- has no signal group (is un-signalized)
    turn-direction Maneuver OPTIONAL,
    -- Indicating the turn direction corresponding to this movement
    ...
  }
```

(2) After receiving the signal priority request initiated by the C-V2X OBU, the C-V2X RSU comprehensively determines, based on the Req-SignalPriority information included in the VIR message and other vehicle information (such as a vehicle position (currentPos), a vehicle planned path (path-Planning), request priority (reqPriority), requested priority duration lifetime, vehicle classification information, and bus occupancy rate information), whether to initiate the signal priority request to the road traffic signal control system. When determining to initiate the signal priority request to the road traffic signal control system, the C-V2X RSU transmits relevant information (such as an intersection requested for signal priority, signal lights requested for signal priority, and a phase requested for signal priority in the Req-SignalPriority information; and requested priority duration (lifetime), a vehicle classification information, and bus occupancy rate information) to the road traffic signal control system as the target signal priority request information. After receiving the target signal priority request information, the road traffic signal control system determines, based on the target signal priority request information, whether to grant signal priority to the vehicle

(3) When determining to grant signal priority to the vehicle, the road traffic signal control system feeds the result back to the C-V2X RSU, and the RSU feeds the result back to the C-V2X OBU based on the RSC message, as shown in Table 2 below, and reference may alternatively be made to the below ASN.1 code.

TABLE 2
Signal priority response (Msg_RSC)

| Data | Remark |
|---|---|
| ID of a response object | ID of the response RSU |
| | (such as id in ASN.1) |
| ID of a vehicle | Such as vehId in ASN.1 |
| transmitting a request | |
| Moment | Moment of transmitting a response |
| | message (such as secMark in ASN.1) |
| Position | Reference position for response RSU |
| | (such as refPos in ASN.1) |
| Response type | Signal priority |
| | (Such as signalPriority in |
| | CoordinationInfo in ASN.1) |
| Signal priority type | Red light truncation, green light extension, |
| | phase maintenance, and phase insertion |
| | (Such as SignalPriorityType in ASN.1) |
| Signal priority duration | Such as signalPriorityTime in ASN.1 |

In embodiments of the present disclosure, the RSC message not only includes whether to give the signal priority information (that is, the signalPriority in the CoordinationInfo) to the vehicle, but also includes more signal priority information about decisions of road traffic signal control system. Therefore, the vehicle not only knows whether the signal priority is obtained, but can also obtain further information for future decisions. For example, the vehicle knows an obtained time period of signal priority based on the signal priority duration information. If a priority effect is not satisfactory based on evaluation on the signal priority duration information, the vehicle may further determine, based on the signal priority duration information, whether to further initiate a signal priority request.

According to embodiments of the present disclosure, the RSC message is enhanced, and more information is added to the RSC message. For example, a “vehicle signal priority request response” data frame is added to the RSC message so that the vehicle obtains the signal priority information provided by the road traffic signal control system.

ASN.1 code of the RSC message enhancement (adding signal priority type and priority duration response) is as follows:

### Msg_RSC

### Definition

It is a message by a road side unit for vehicle collaboration or guidance. It is usually used for broadcast, multicast, or unicast to provide guidance information and driving decision support to a vehicle. The message may guide a single vehicle, or may guide qualified vehicles on specific road sections and lanes.

[ASN.1 code]

```
  RoadsideCoordination ::= SEQUENCE {
    msgCntMsgCount,
    id OCTET STRING (SIZE(8)),
    -- temporary RSU ID
    secMarkDSecond,
    refPos Position3D,
    -- Reference position of this RSC message
    coordinates SEQUENCE (SIZE(1..16)) OF
VehicleCoordinationOPTIONAL,
    -- Coordination with single vehicle
    laneCoordinates SEQUENCE (SIZE(1..8)) OF LaneCoordination
OPTIONAL,
    -- Lane or link level coordination
    ...
  }
```

According to embodiments of the present disclosure, the VehicleCoordination data frame in the RSC message is enhanced and a “vehicle signal priority request response” data frame is added.

### DF_VehicleCoordination

It defines RSU's coordinated planning information for a single vehicle.

It includes the vehicle's temporary identifier (ID), and information such as driving suggestions and path planning provided by the RSU.

[ASN.1 code]

```
    VehicleCoordination ::= SEQUENCE {
      vehId OCTET STRING (SIZE(8)),
      -- Temp ID of the target vehicle -- i.e., temporary identifier (ID)
of the vehicle
    driveSuggestionDriveSuggestion OPTIONAL, -- i.e., driving
suggestions provided by the RSU, which are optional
      pathGuidancePathPlanning OPTIONAL,
      -- Coordination using path guidance -- i.e., path planning provided
by the RSU, which is optional
    info CoordinationInfo OPTIONAL,
      -- Detailed use cases related to current coordination, which is
      optional
  signalPriorityInfoResp-SPInfo OPTIONAL,
      ...
    }
```

### DF_Resp-SPInfo

### Definition

It defines a response message for a vehicle signal priority request

[ASN.1 code]

```
Resp-SPInfo:= SEQUENCE {
  signalPriorityTypeResp-PriorityType OPTIONAL,
  -- signal priority type
  signalPriorityTimeTimeOffse OPTIONAL,
-- signal priority time
  ...
}
```

### DE_Resp-PriorityType

### Definition

It defines a response type for a vehicle signal priority request.

[ASN.1 code]

```
Resp-PriorityType:= ENUMERATED {
  redTruncation(0), -- red light truncation
  greenExtension(1), -- green light extension
  phaseMaintain(2), -- traffic signal phase maintain
  phaseInsertion(3), -- traffic signal phase insertion
  ...
}
```

### DE_CoordinationInfo

### Definition

It defines a use case type corresponding to single vehicle coordination planning information.

It represents an application scenario of specific road side guidance. It includes:
cooperativeLaneChanging: cooperative lane changing;
cooperative VehMerging: cooperative vehicle merging;
laneChangingAtIntersection: lane changing at an intersection;
no-signalIntersectionPassing: passing through a no-signal intersection;
dynamicLaneManagement: dynamic lane management;
laneReservation: lane reservations;
laneRestriction: lane restriction;
signalPriority: signal priority.

[ASN.1 code]

```
CoordinationInfo ::= BIT STRING {
  cooperativeLaneChanging(0),
  cooperativeVehMerging(1),
  laneChangingAtIntersection(2),
  no-signalIntersectionPassing(3),
  dynamicLaneManagement(4),
  laneReservation(5),
  laneRestriction(6),
  signalPriority(7)
} (SIZE(8,...))
```

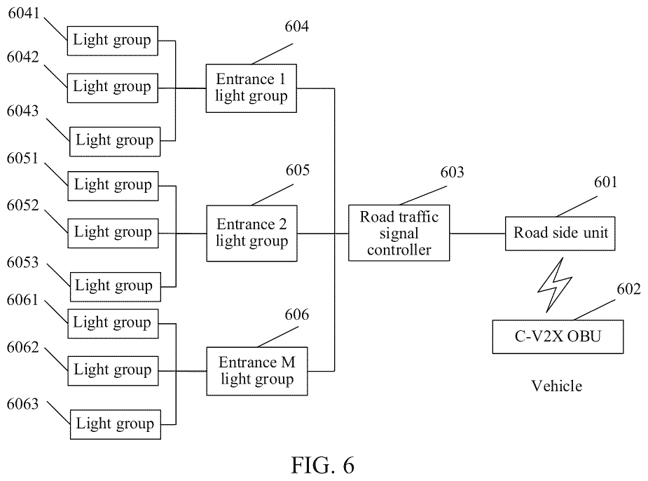

FIG. 6 is a diagram of a traffic control architecture according to an embodiment of the present disclosure.

In FIG. 6, a road side unit 601 may be connected, based on a C-V2X technology, to a road traffic signal controller 603 and a C-V2XOBU 602 included in a vehicle. By using the C-V2XOBU 602 included in the vehicle, the road side unit 601 may obtain a VIR message transmitted by the vehicle.

After receiving the VIR message, the road side unit 601 may determine whether to transmit target signal priority request information carried in the VIR message to the road traffic signal controller 603. The road traffic signal controller 603 may be connected to a plurality of entrance light groups separately, and each entrance light group may be connected to a plurality of light groups. As shown in FIG. 6, the road traffic signal controller 603 is separately connected to an entrance 1 light group 604, an entrance 2 light group 605, . . . , and an entrance M (where M is a positive integer greater than or equal to 1) light group 606. Each entrance light group may be connected to a plurality of light groups separately. As shown in FIG. 6, the entrance 1 light group 604 is separately connected to a plurality of light groups such as a light group 6041, a light group 6042, . . . , and a light group 6043. The entrance 2 light group 605 is separately connected to a plurality of light groups such as a light group 6051, a light group 6052, . . . , and a light group 6053. The entrance M light group 606 is separately connected to a plurality of light groups such as a light group 6061, a light group 6062, . . . , and a light group 6063. After the road traffic signal controller 603 responds to the target signal priority request information, a light group of at least one entrance may be controlled to implement traffic control. Furthermore, the road traffic signal controller 603 may return signal priority response information to the road side unit 601.

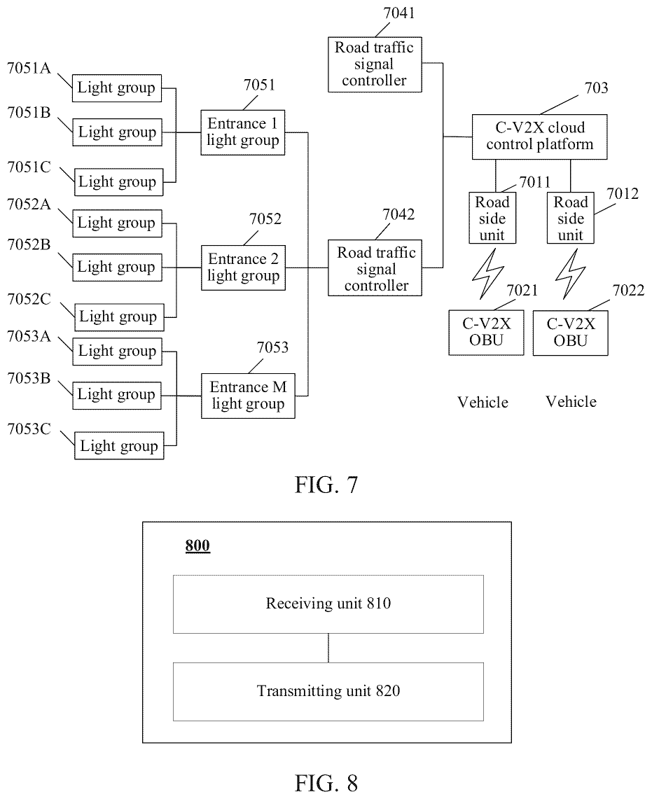

FIG. 7 is a diagram of another traffic control architecture according to an embodiment of the present disclosure. FIG. 7 may be used for trunk line or area signal priority (that is, there are a plurality of intersections).

In FIG. 7, a plurality of road side units may be connected, based on a C-V2X technology, to a C-V2X cloud control platform and a C-V2XOBU included in a vehicle. By using the C-V2XOBU included in the vehicle, any road side unit may obtain a VIR message transmitted by the vehicle.

As shown in FIG. 7, both a road side unit 7011 and a road side unit 7012 may be connected to a C-V2X cloud control platform 703. Moreover, the road side unit 7011 may be connected to a C-V2XOBU 7021, and the road side unit 7012 may be connected to a C-V2XOBU 7022. After receiving VIR messages transmitted by the C-V2XOBU 7021 and the C-V2XOBU 7022 respectively, the road side unit 7011 and the road side unit 7012 may transmit target signal priority request information carried in each VIR message to the C-V2X cloud control platform 703. The C-V2X cloud control platform 703 is connected to a road traffic signal controller 7041 and a road traffic signal controller 7042, and the C-V2X cloud control platform 703 may transmit each piece of target signal priority request information to a corresponding road traffic signal controller. The road traffic signal controller 7041 and the road traffic signal controller 7042 may each be connected to a plurality of entrance light groups respectively, and each entrance light group may be connected to a plurality of light groups. As shown in FIG. 7, the road traffic signal controller 7042 is separately connected to an entrance 1 light group 7051, an entrance 2 light group 7052, . . . , and an entrance M light group 7053. Each entrance light group may be connected to a plurality of light groups separately. As shown in FIG. 7, the entrance 1 light group 7051 is separately connected to a plurality of light groups such as a light group 7051A, a light group 7051B, . . . , and a light group 7051C. The entrance 2 light group 7052 is separately connected to a plurality of light groups such as a light group 7052A, a light group 7052B, . . . , and a light group 7052C. The entrance M light group 7053 is separately connected to a plurality of light groups such as a light group 7053A, a light group 7053B, . . . , and a light group 7053C. After the road traffic signal controller responds to the target signal priority request information, a light group of at least one entrance may be controlled to implement traffic control. Furthermore, the road traffic signal controller may return signal priority response information to the C-V2X cloud control platform. The C-V2X cloud control platform may forward the signal priority response information to a corresponding road side unit, and each road side unit may return a corresponding RSC message to a corresponding C-V2XOBU. Under this architecture, a plurality of road traffic signal controllers may be distinguished based on sender and receiver identifiers. Based on the identifiers, unique identities of the sender and receiver may be determined.

FIG. 8 is a schematic diagram of a traffic control apparatus according to an embodiment of the present disclosure. The apparatus is deployed in a road side unit. As shown in FIG. 8, the traffic control apparatus 800 may include a receiving unit 810 and a transmitting unit 820.

The receiving unit 810 may be configured to receive a vehicle intention and request message transmitted by a vehicle, where the vehicle intention and request message may include signal priority request information, and the signal priority request information may include at least one of classification information and load information of the vehicle.

The transmitting unit 820 may be configured to transmit target signal priority request information in the vehicle intention and request message to a road traffic signal control system, where the signal priority request information includes the target signal priority request information, and the target signal priority request information may include at least one of the classification information and the load information of the vehicle.

The target signal priority request information may be configured for instructing the road traffic signal control system to determine, based on the target signal priority request information, whether to allow for priority passage of the vehicle.

In an exemplary embodiment, when the signal priority request information includes the classification information of the vehicle, the vehicle intention and request message may include a data frame of a vehicle classification.

The data frame of the vehicle classification may be configured for carrying the classification information of the vehicle.

In an exemplary embodiment, the classification information of the vehicle may include basic class information of the vehicle.

The data frame of the vehicle classification may include a data element of a basic vehicle class.

The data element of the basic vehicle class may be configured for carrying the basic class information of the vehicle.

In an exemplary embodiment, the classification information of the vehicle may further include fuel power type information of the vehicle.

The data frame of the vehicle classification further may include a data element of a fuel power type.

The data element of the fuel power type may be configured for carrying the fuel power type information of the vehicle.

In an exemplary embodiment, the vehicle intention and request message may include a data frame of intention and request data.

The data frame of the intention and request data may include a data frame of a driving request.

The data frame of the driving request may include a data frame of request information.

The data frame of the request information may determine a data frame of a signal priority request.

When the signal priority request information includes the load information of the vehicle, and the vehicle is a bus, the data frame of the signal priority request may include a data element of a bus occupancy rate.

The data element of the bus occupancy rate may be configured for carrying the load information of the vehicle.

In an exemplary embodiment, the receiving unit 810 may further be configured to receive signal priority response information transmitted by the road traffic signal control system, where the signal priority response information includes at least one of signal priority type information and signal priority duration information. The traffic control apparatus 800 may further include a processing unit. The processing unit may be configured to generate a road side coordination message based on the signal priority response information, where the road side coordination message may include at least one of the signal priority type information and signal priority duration information. The transmitting unit 820 may further be configured to transmit the road side coordination message to the vehicle.

In an exemplary embodiment, the road side coordination message may include a data frame of vehicle coordination.

The data frame of the vehicle coordination may include a data frame of signal priority information response.

The data frame of the signal priority information response may include at least one of a data element of a signal priority type and a data element of signal priority duration.

The data element of the signal priority type may be configured for indicating the signal priority type information.

The data element of the signal priority duration may be configured for indicating the signal priority duration information.

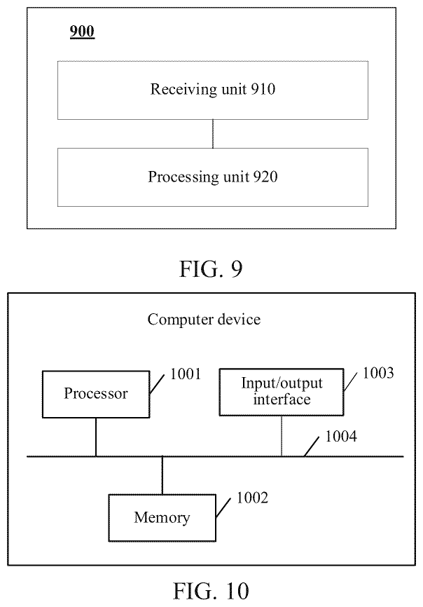

FIG. 9 is a schematic diagram of a traffic control apparatus according to an embodiment of the present disclosure. The apparatus is deployed in a road side unit. As shown in FIG. 9, the traffic control apparatus 900 may include a receiving unit 910 and processing unit 920.

The receiving unit 910 may be configured to receive a vehicle intention and request message transmitted by a vehicle, where the vehicle intention and request message may include signal priority request information, and the signal priority request information may include at least one of classification information and load information of the vehicle.

The processing unit 920 may be configured to determine, based on the signal priority request information, whether to transmit target signal priority request information in the vehicle intention and request message to a road traffic signal control system, where the signal priority request information includes the target signal priority request information, and the target signal priority request information may include at least one of the classification information and the load information of the vehicle.

Embodiments of the present disclosure further provide a traffic control apparatus. The apparatus is deployed in a vehicle. The traffic control apparatus may include a transmitting unit.

The transmitting unit may be configured to transmit a vehicle intention and request message to a road side unit, the vehicle intention and request message including signal priority request information, and the signal priority request information including at least one of classification information and load information of the vehicle.

The vehicle intention and request message is configured for instructing the road side unit to transmit target signal priority request information in the vehicle intention and request message to a road traffic signal control system. The signal priority request information includes the target signal priority request information, and the target signal priority request information includes at least one of the classification information and the load information of the vehicle.

Embodiments of the present disclosure further provide a traffic control apparatus. The apparatus is deployed in a vehicle. The traffic control apparatus may include a transmitting unit.

The transmitting unit may be configured to transmit a vehicle intention and request message to a road side unit. The vehicle intention and request message includes signal priority request information, and the signal priority request information includes at least one of classification information and load information of the vehicle.

The vehicle intention and request message is configured for instructing the road side unit to determine, based on the signal priority request information, whether to transmit target signal priority request information in the vehicle intention and request message to a road traffic signal control system. The signal priority request information includes the target signal priority request information, and the target signal priority request information includes at least one of the classification information and the load information of the vehicle.

FIG. 10 is a schematic diagram of a structure of a computer device according to an embodiment of the present disclosure. As shown in FIG. 10, the computer device in embodiments of the present disclosure may include: one or more processors 1001, a memory 1002, and an input/output interface 1003. The processor 1001, the memory 1002, and the input/output interface 1003 are connected via a bus 1004. The memory 1002 is configured to store a computer program. The computer program includes program instructions. The input/output interface 1003 is configured to receive data and output data. For example, the input/output interface 1003 is used for data exchange between a host machine and the computer device, or for data exchange between virtual machines in the host machine. The processor 1001 is configured to execute the program instructions stored in the memory 1002.

The processor 1001 may perform any traffic control method on a road side unit side or any traffic control method on a vehicle side in the following embodiments of the present disclosure.

In some feasible implementations, the processor 1001 may be a central processing unit (CPU), or the processor may be another general purpose-processor, digital signal processor (DSP), application specific integrated circuit (ASIC), field-programmable gate array (FPGA) or another programmable logic device, discrete gate or transistor logic device, discrete hardware component, or the like. The general-purpose processor may be a microprocessor, or the processor may be any conventional processor or the like.

The memory 1002 may include a read-only memory and a random access memory, and provide instructions and data for the processor 1001 and the input/output interface 1003. A part of the memory 1002 may further include a non-volatile random access memory. For example, the processor 1002 may further store information about a device type.

In specific implementation, by using built-in functional modules, the computer device may perform implementations provided in operations in any one of the method embodiments. For details, reference may be made to implementations provided in operations in the figures shown in the foregoing method embodiments, and details are not described herein again.

Embodiments of the present disclosure further provide a computer-readable storage medium having a computer program stored thereon. The computer program is loadable and executable by the processor to perform the traffic control method provided in operations in any of the foregoing embodiments. For details, reference may be made to implementations provided in the operations in any one of the foregoing embodiments, and details are not described herein again. In addition, the description of beneficial effects of the same method are not described herein again. For technical details not disclosed in the computer-readable storage medium embodiment involved in the present disclosure, reference may be made to the descriptions of method embodiments of the present disclosure. As an example, the computer program may be deployed to be executable on one computer device or on a plurality of computer devices located in one position, alternatively, on a plurality of computer devices distributed in a plurality of positions and interconnected via communication networks.

The computer-readable storage medium may be an internal storage unit of the computer device provided in any one of the foregoing embodiments, such as a hard disk or a memory of the computer device. The computer-readable storage medium may alternatively be an external storage device of the computer device, such as a plug-in hard disk, a smart media card (SMC), a secure digital (SD) card, or a flash card equipped on the computer device. Further, the computer-readable storage medium may alternatively include both an internal storage unit and an external storage device of the computer device. The computer-readable storage medium is configured to store the computer program and other programs and data needed by the computer device. The computer-readable storage medium may further be configured to temporarily store data that has been outputted or is to be outputted.

Embodiments of the present disclosure further provide a computer program product or a computer program. The computer program product or the computer program includes computer instructions. The computer instructions are stored on a computer-readable storage medium. A processor of a computer device reads the computer instructions from the computer-readable storage medium, and the processor executes the computer instructions, to cause the computer device to perform the method provided in various implementations in any one of the foregoing embodiments.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A traffic control method, performed by a road side unit, the method comprising:
receiving a vehicle intention and request message transmitted by a vehicle, the vehicle intention and request message comprising signal priority request information, the signal priority request information comprising target signal priority request information, and the target signal priority request information comprising at least one of: classification information or load information of the vehicle; and
transmitting the target signal priority request information in the vehicle intention and request message to a road traffic signal control system, wherein the target signal priority request information is configured to instruct the road traffic signal control system to determine, based on the target signal priority request information, whether to allow for priority passage of the vehicle.

2. The method according to claim 1, wherein the signal priority request information comprises the classification information of the vehicle, the vehicle intention and request message comprises a data frame of a vehicle classification; and
the data frame of the vehicle classification is configured to carry the classification information of the vehicle.

3. The method according to claim 2, wherein the classification information of the vehicle comprises basic class information of the vehicle;
the data frame of the vehicle classification comprises a data element of a basic vehicle class; and
the data element of the basic vehicle class is configured to carry the basic class information of the vehicle.

4. The method according to claim 3, wherein the classification information of the vehicle further comprises fuel power type information of the vehicle;
the data frame of the vehicle classification further comprises a data element of a fuel power type; and
the data element of the fuel power type is configured to carry the fuel power type information of the vehicle.

5. The method according to claim 1, wherein the vehicle intention and request message comprises a data frame of intention and request data.

6. The method according to claim 5, wherein the data frame of the intention and request data comprises a data frame of a driving request;
the data frame of the driving request comprises a data frame of request information;
the data frame of the request information comprises a data frame of a signal priority request.

7. The method according to claim 6, wherein when the signal priority request information comprises the load information of the vehicle, and the vehicle is a bus, the data frame of the signal priority request comprises a data element of a bus occupancy rate; and
the data element of the bus occupancy rate is configured to carry the load information of the vehicle.

8. The method according to claim 1, further comprising:
receiving signal priority response information transmitted by the road traffic signal control system, the signal priority response information comprising at least one of signal priority type information or signal priority duration information.

9. The method according to claim 8, further comprising:
generating a road side coordination message based on the signal priority response information, the road side coordination message comprising at least one of the signal priority type information or the signal priority duration information; and
transmitting the road side coordination message to the vehicle.

10. The method according to claim 9, wherein the road side coordination message comprises a data frame of vehicle coordination.

11. The method according to claim 10, wherein the data frame of the vehicle coordination comprises a data frame of signal priority information response.

12. The method according to claim 10, wherein the data frame of the signal priority information response comprises at least one of a data element of a signal priority type or a data element of signal priority duration.

13. The method according to claim 12, wherein the data frame of the signal priority information response comprises the data element of the signal priority type, the data element of the signal priority type configured to carry the signal priority type information.

14. The method according to claim 12, wherein the data frame of the signal priority information response comprises the data element of the signal priority duration, the data element of the signal priority duration configured to carry the signal priority duration information.

15. A traffic control apparatus, deployed in a road side unit, the apparatus comprising:
a memory storing a plurality of instructions; and
a processor configured to execute the plurality of instructions, and upon execution of the plurality of instructions, the processor is configured to:
receive a vehicle intention and request message transmitted by a vehicle, the vehicle intention and request message comprising signal priority request information, the signal priority request information comprising target signal priority request information, and the target signal priority request information comprising at least one of classification information or load information of the vehicle; and
transmit the target signal priority request information in the vehicle intention and request message to a road traffic signal control system, wherein the target signal priority request information is configured to instruct the road traffic signal control system to determine, based on the target signal priority request information, whether to allow for priority passage of the vehicle.

16. The traffic control apparatus according to claim 15, wherein the signal priority request information comprises the classification information of the vehicle, the vehicle intention and request message comprises a data frame of a vehicle classification; and
the data frame of the vehicle classification is configured to carry the classification information of the vehicle.

17. The traffic control apparatus according to claim 15, wherein the vehicle intention and request message comprises a data frame of intention and request data, wherein the data frame of the intention and request data comprises a data frame of a driving request, the data frame of the driving request comprises a data frame of request information, and the data frame of the request information comprises a data frame of a signal priority request.

18. The traffic control apparatus according to claim 15, wherein the processor, upon execution of the plurality of instructions, is further configured to:
receive signal priority response information transmitted by the road traffic signal control system, the signal priority response information comprising at least one of signal priority type information or signal priority duration information;
generate a road side coordination message based on the signal priority response information, the road side coordination message comprising at least one of the signal priority type information or the signal priority duration information; and
transmit the road side coordination message to the vehicle.

19. The traffic control apparatus according to claim 18, wherein the road side coordination message comprises a data frame of vehicle coordination.

20. A non-transitory computer readable storage medium storing a plurality of instructions executable by a processor, wherein upon execution by the processor, the plurality of instructions is configured to cause the processor to:
receive a vehicle intention and request message transmitted by a vehicle, the vehicle intention and request message comprising signal priority request information, the signal priority request information comprising target signal priority request information, and the target signal priority request information comprising at least one of classification information or load information of the vehicle; and
transmit the target signal priority request information in the vehicle intention and request message to a road traffic signal control system, wherein the target signal priority request information is configured to instruct the road traffic signal control system to determine, based on the target signal priority request information, whether to allow for priority passage of the vehicle.
